(19) United States
(12) Patent Application Publication
(10) Pub. No.: US 2026/0291770 A1
(43) Pub. Date: Sep. 24, 2026

(54) ELECTRONIC APPARATUS AND CONTROL METHOD THEREOF

(71) Applicant: SAMSUNG ELECTRONICS CO., LTD., Suwon-si (KR)

(72) Inventors: Hyungchul KIM, Suwon-si (KR); Kihong Park, Suwon-si (KR)

(73) Assignee: SAMSUNG ELECTRONICS CO., LTD., Suwon-si (KR)

(21) Appl. No.: 19/644,426

(22) Filed: Apr. 10, 2026

Related U.S. Application Data
(63) Continuation of application No. PCT/KR2026/002314, filed on Feb. 6, 2026.

(30) Foreign Application Priority Data
Mar. 18, 2025 (KR) 10-2025-0034831

(51) Int. Cl. H04L 12/28

(52) U.S. Cl. CPC H04L 12/282; H04L 12/2818

(57) ABSTRACT

An electronic apparatus includes a communication interface; a display; memory configured to store at least one instruction; and at least one processor, wherein the at least one instruction, when executed by the at least one processor individually or collectively, causes the electronic apparatus to: display a first screen on the display; obtain status information from a hub device through the communication interface; identify whether the hub device is turned on based on the status information; and based on identifying that the hub device is turned on, control a screen displayed on the display based on whether an external device is connected to the hub device.

### CROSS-REFERENCE TO RELATED APPLICATION

This application is a continuation application of International Application No. PCT/KR2026/002314, filed on February 6, 2026, which claims priority to Korean Patent Application No. 10-2025-0034831, filed on March 18, 2025, in the Korean Intellectual Property Office, the disclosures of which are incorporated herein by reference in their entireties.

### BACKGROUND

### 1. Field

The disclosure relates to an electronic apparatus and a control method thereof.

### 2. Description of Related Art

In the related art, external electronic apparatuses, such as set-top boxes, game consoles, and smartphones, may be connected to electronic apparatuses that provide video signals, such as televisions (TVs), to provide users with a variety of content.

In this case, external input signals may be reliably transmitted to a display device, such as a TV, through a hub device connected to a plurality of external electronic apparatuses. However, the hub device may not be permanently connected to the electronic apparatus, and some users may choose to turn it off.

Therefore, a user experiences the inconvenience of having to turn on the hub device to view a screen of an external input device and then perform a separate operation to switch to an external input. Accordingly, there is a need for a method for efficiently switching to an external input screen on an electronic apparatus.

### SUMMARY

According to an aspect of the disclosure, there is provided an electronic apparatus including: a communication interface; a display; memory configured to store at least one instruction; and at least one processor, wherein the at least one instruction, when executed by the at least one processor individually or collectively, causes the electronic apparatus to: display a first screen on the display; obtain status information from a hub device through the communication interface; identify whether the hub device is turned on based on the status information; and based on identifying that the hub device is turned on, control a screen displayed on the display based on whether an external device is connected to the hub device.

The at least one instruction, when executed by the at least one processor individually or collectively, causes the electronic apparatus to: based on the external device being connected to the hub device, obtain content information provided by the external device from the hub device through the communication interface and display, on the display, a second screen corresponding to the content information.

The at least one instruction, when executed by the at least one processor individually or collectively, may cause the electronic apparatus to: based on the external device not being connected to the hub device, identify whether a new external device is connected to the hub device within a predetermined period of time; and based on identifying that the new external device is not connected to the hub device within the predetermined period of time, maintain the display of the first screen on the display.

The at least one instruction, when executed by the at least one processor individually or collectively, may cause the electronic apparatus to: based on identifying that the new external device is connected to the hub device within the predetermined period of time, obtain content information provided by the new external device from the hub device through the communication interface; and display, on the display, a second screen corresponding to the content information.

The at least one instruction, when executed by the at least one processor individually or collectively, may cause the electronic apparatus to: based on a plurality of external devices being connected to the hub device, obtain content information provided by the plurality of external devices from the hub device through the communication interface; and display, on the display, a third screen including information on the plurality of external devices.

The at least one instruction, when executed by the at least one processor individually or collectively, may cause the electronic apparatus to, based on an input for selecting one of the plurality of external devices being received, display, on the display, a second screen corresponding to content information provided by the selected external device.

The status information may include at least one of identification information of the hub device, power information of the hub device, or connection information.

According to an aspect of the disclosure, there is provided a method of controlling an electronic apparatus, the method including: displaying a first screen on a display of the electronic apparatus; obtaining status information from a hub device; identifying whether the hub device is turned on based on the status information; and based on identifying that the hub device is turned on, controlling a screen displayed on the display based on whether an external device is connected to the hub device.

The controlling of the screen displayed on the display may include: based on the external device being connected to the hub device, obtaining content information provided by the external device from the hub device; and displaying, on the display, a second screen corresponding to the content information.

The controlling of the screen displayed on the display may further include: based on the external device not being connected to the hub device, identifying whether a new external device is connected to the hub device within a predetermined period of time; and based on identifying that the new external device is not connected to the hub device within the predetermined period of time, maintaining the displaying of the first screen.

The controlling of the screen displayed on the display may further include: based on identifying that the new external device is connected to the hub device within the predetermined period of time, obtaining content information provided by the new external device from the hub device; and displaying, on the display, a second screen corresponding to the content information.

The controlling of the screen displayed on the display may further include: based on a plurality of external devices being connected to the hub device, obtaining content information provided by the plurality of external devices from the hub device; and displaying, on the display, a third screen including information on the plurality of external devices.

The controlling of the screen displayed on the display may further include, based on an input for selecting one of the plurality of external devices being received, displaying, on the display, a second screen corresponding to content information provided by the selected external device.

The status information may include at least one of identification information of the hub device, power information of the hub device, or connection information.

According to an aspect of the disclosure, there is provided a non-transitory computer-readable recording medium storing a program that is executed by at least one processor of an electronic apparatus to perform a method including: displaying a first screen on a display of the electronic apparatus; obtaining status information from a hub device; identifying whether the hub device is turned on based on the status information; and based on identifying that the hub device is turned on, controlling a screen displayed on the display based on whether an external device is connected to the hub device.

The controlling of the screen displayed on the display may include: based on the external device being connected to the hub device, obtaining content information provided by the external device from the hub device; and displaying, on the display, a second screen corresponding to the content information.

The controlling of the screen displayed on the display may further include: based on the external device not being connected to the hub device, identifying whether a new external device is connected to the hub device within a predetermined period of time; and based on identifying that the new external device is not connected to the hub device within the predetermined period of time, maintaining the displaying of the first screen.

The controlling of the screen displayed on the display may further include: based on identifying that the new external device is connected to the hub device within the predetermined period of time, obtaining content information provided by the new external device from the hub device; and displaying, on the display, a second screen corresponding to the content information.

The controlling of the screen displayed on the display may further include: based on a plurality of external devices being connected to the hub device, obtaining content information provided by the plurality of external devices from the hub device; and displaying, on the display, a third screen including information on the plurality of external devices.

The controlling of the screen displayed on the display may further include, based on an input for selecting one of the plurality of external devices being received, displaying, on the display, a second screen corresponding to content information provided by the selected external device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating an operation of an electronic apparatus according to at least one embodiment of the disclosure;

FIG. 2 is a diagram illustrating a configuration of an electronic apparatus according to at least one embodiment of the disclosure;

FIG. 3 is a block diagram illustrating a configuration of a hub device according to at least one embodiment of the disclosure;

FIG. 4 is a flowchart illustrating a method of controlling a screen by an electronic apparatus depending on whether a hub device is powered on according to at least one embodiment of the disclosure;

FIG. 5 is a diagram illustrating operations of an electronic apparatus, a hub device, and an external device based on the hub device and the external device being connected according to at least one embodiment of the disclosure;

FIG. 6 is a diagram illustrating operations of an electronic apparatus, a hub device, and an external device based on the hub device and the external device being not connected according to at least one embodiment of the disclosure;

FIG. 7 is a diagram illustrating an operation of an electronic apparatus based on a hub device, to which a plurality of external devices are connected, being powered on according to an embodiment of the disclosure; and

FIG. 8 is a flowchart illustrating a method of controlling an electronic apparatus according to an embodiment of the disclosure.

### DETAILED DESCRIPTION

The terms used in the example embodiments of the disclosure are general terms which are widely used now and selected considering the functions of the disclosure. However, the terms may vary depending on the intention of a person skilled in the art, a precedent, or the advent of new technology. In addition, in a specified case, the term may be arbitrarily selected. In this case, the meaning of the term will be explained in the corresponding description. Therefore, terms used in the disclosure may be defined based on a meaning of the terms and contents described in the disclosure, not simply based on names of the terms.

As used herein, the expression “have”, “may have”, “include”, or “may include” refers to the existence of a corresponding feature (e.g., numeral, function, operation, or constituent element, such as component), and does not exclude one or more additional features.

The expression of “at least one of A or B” is to be understood as indicating any one of “A” or “B” or “A and B”.

The expression “a first”, “a second”, “the first”, or “the second” used in various example embodiments of the disclosure may modify various components regardless of their order and/or the importance but does not limit the corresponding components.

It should be understood that when an element (e.g., first element) is referred to as being (operatively or communicatively) “connected,” or “coupled,” to another element (e.g., second element), it may be directly connected or coupled directly to the other element or another element (e.g., third element) may be interposed between them.

A singular expression includes a plural expression as long as they are clearly distinguished in the context. In the application, it should be understood that the terms, such as “comprising”, “including” are intended to express that features, numbers, steps, operations, constituent elements, part, or combinations thereof described in the specification are present and do not exclude existence or additions of one or more other features, numbers, steps, operations, constituent elements, part, or combinations thereof.

In the description, the word “module” or “unit” refers to a software component, a hardware component, or a combination thereof, which is capable of carrying out at least one function or operation. A plurality of modules or units may be integrated into at least one module and implemented using at least one processor except for those modules or units that need to be implemented in specific hardware.

In this disclosure, the term “user” may indicate a person who uses an electronic apparatus or a device (e.g., an artificial intelligence electronic apparatus) that uses an electronic apparatus.

Hereinafter, example embodiments of the disclosure will be described in detail with reference to the accompanying drawings.

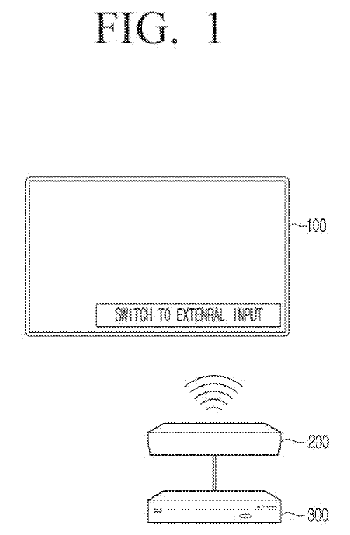

FIG. 1 is a diagram schematically illustrating an operation of an electronic apparatus 100 according to at least one embodiment of the disclosure.

In at least one embodiment of the disclosure, the electronic apparatus 100 may be a device that displays an image and provides the image to a user. The electronic apparatus 100 may display content provided from a hub device 200. Specifically, the electronic apparatus 100 may be a device that receives content information from the hub device 200 and displays a screen corresponding to the received content information. However, embodiments of the disclosure are not limited thereto, and the electronic apparatus 100 may also receive content directly from an external device 300 and display the received content.

In FIG. 1, the electronic apparatus 100 is depicted as a TV including a display. However, various embodiments of the disclosure may be implemented in various types of electronic apparatuses, not just TVs. Even if the electronic apparatus 100 does not directly include a display, electronic apparatus 100 may be implemented as a device connected to a separately provided external display device to provide images. In an embodiment, the electronic apparatus 100 may include a display and display a screen corresponding to the received content information through the display. In another embodiment, the electronic apparatus 100 may include a projector and display a screen corresponding to the received content information by projecting the screen onto a projection surface through a projector.

Also, the hub device 200 may be a device, such as a One Connect Box, that transmits content received from at least one of a plurality of external devices to the electronic apparatus 100. However, the hub device 200 does not necessarily transmit only content received from external devices; the hub device 200 may also transmit content stored in a memory thereof to the electronic apparatus 100. For example, the hub device 200 may decode content and transmit video and audio signals of the decoded content to the electronic apparatus 100. In this case, the hub device 200 may convert the video and audio signals of the decoded content into optical signals and transmit the optical signals to the electronic apparatus 100. However, without being limited thereto, the hub device 200 may transmit the video and audio signals of the decoded content to the electronic apparatus 100 without conversion or may convert the video and audio signals of the decoded content into any other type of signals and transmit the same to the electronic apparatus 100. The hub device 200 may be connected to the electronic apparatus 100 wiredly or wirelessly to transmit content to the electronic apparatus 100. Alternatively, the hub device 200 may refer to a wired or wireless transmission device, an intermediary device, or a connection device.

The external device 300 may refer to a device that provides content. The external device 300 may be connected to the hub device 200 and provide content to the electronic apparatus 100 via the hub device 200. For example, the external device 300 may be implemented in various forms, such as a set-top box, PC, laptop PC, smartphone, tablet PC, game console, or Blu-ray player. In FIG. 1, the external device 300 is illustrated as being connected to the hub device 200 wiredly. However, this is merely an example, and the external device 300 may also be connected wirelessly to the hub device 200. Alternatively, the external device may refer to an external input device or an external input source.

It should be noted that the external device 300 may be directly connected to the electronic apparatus 100 to provide content. That is, the electronic apparatus 100 may receive content information from the external device 300 and display a screen corresponding to the received content information.

However, for convenience of description, it is assumed that the electronic apparatus 100 receives content provided by the external device 300 from the hub device 200 and displays the received content.

The electronic apparatus 100 may display a first screen. The first screen may refer to a screen displayed before the electronic apparatus 100 switches to displaying content from the hub device 200. Alternatively, the first screen may refer to a default screen, a previous screen, or a TV mode screen.

The electronic apparatus 100 may receive status information from the hub device 200. The status information may refer to information regarding the status of the hub device 200. The status information may include at least one of identification information of the hub device 200, power information of the hub device 200, or connection information.

The identification information of the hub device 200 may refer to information for the electronic apparatus 100 to identify the hub device 200. For example, the identification information may include extended display identification data (EDID), MAC address, IP address, universally unique identifier (UUID) information, serial number, and IMEI number of the hub device 200.

The power information of the hub device 200 may refer to information on whether the hub device 200 is powered on. Power information may include information on whether the hub device 200 is powered on/off or in standby mode. The power information may also be referred to as power status information or standby mode status information.

The connection information of the hub device 200 may refer to information on the connection of the hub device 200 to the electronic apparatus 100 or the external device 300. The connection information may include the number of external devices connected to the hub device 200, information on the external devices connected to the hub device 200, and information on whether the hub device 200 is available to be connected to the electronic apparatus 100.

The electronic apparatus 100 may identify whether the hub device 200 is turned on based on the received status information. “Turning on” may mean that the hub device 200, which has been powered off, is turned on. Alternatively, “Turning on” may mean that the hub device 200 is switched from a standby mode to an active mode. In other words, the electronic apparatus 100 may identify whether the hub device 200 is turned on based on the received status information. Since the user likely turned on the hub device 200 to use the hub device 200, the electronic apparatus 100 may identify the user’s intent to switch to an external input screen by identifying whether the hub device 200 is turned on.

Based on identifying that the hub device 200 is turned on, the electronic apparatus 100 may control the screen displayed based on the presence or absence of an external device connected to the hub device 200. The electronic apparatus 100 may display a second screen based on the hub device 200 is identified as powered on and the external device 300 connected to the hub device 200 is present. That is, based on the hub device 200, connected to the external device 300, being powered on, the electronic apparatus 100 may switch from the first screen to the second screen.

Here, the second screen may refer to a screen displaying content provided by the external device 300. In other words, the second screen may refer to an external input screen. For example, based on a tablet PC being connected to the hub device 200, the electronic apparatus 100 may receive content information provided by the tablet PC from the hub device 200 and display a screen (i.e., the second screen) corresponding to the content information. The second screen may also refer to an external input mode screen or an input source screen.

The electronic apparatus 100 may maintain the first screen based on the hub device 200 is identified as being powered on and there is no external device 300 connected to the hub device 200.

Hereinafter, a specific method of controlling the screen of the electronic apparatus 100 based on whether the hub device 200 is turned on and the presence or absence of the external device 300 connected to the hub device 200 will be described.

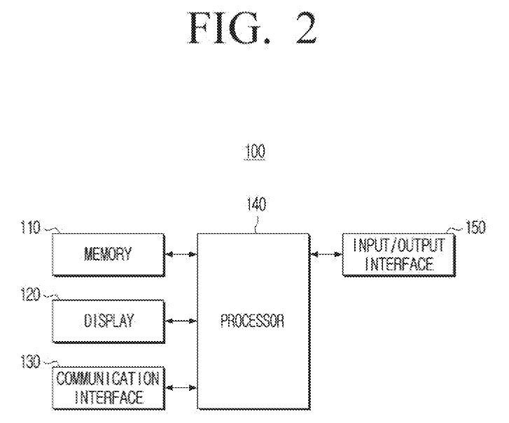

FIG. 2 is a diagram illustrating a configuration of the electronic apparatus 100 according to at least one embodiment of the disclosure.

Referring to FIG. 2, the electronic apparatus 100 according to the disclosure may include memory 110, a display 120, a communication interface 130, at least one processor 140 (hereafter “the processor 140”), and an input/output interface 150. However, this configuration is an example, and it is understood that new components may be added or some components may be omitted based on implementation of the disclosure. For example, the electronic apparatus 100 may include an operation interface, a projector, etc.

The memory 110 may store data necessary for the operation of the electronic apparatus 100 according to various embodiments of the disclosure. Depending on the data storage purpose, the memory 110 may be implemented as memory embedded in the electronic apparatus 100 (e.g., volatile memory (e.g., semi-permanent memory, such as random access memory (RAM)), non-volatile memory (e.g., permanent memory, such as read-only memory (ROM)), flash memory, a hard drive, a solid-state drive, etc.), or memory detachably attached to the electronic apparatus 100 (e.g., a memory card, external memory, etc.).

Instructions may be stored in the memory 110. The processor 140 may perform operations of the electronic apparatus 100 according to various embodiments of the disclosure by individually or collectively executing the instructions in the memory 110. In addition, programs and data for operating the electronic apparatus 100 may be stored in the memory 110. For example, the memory 110 may store one or more software applications, such as an operating system (or system) software application, a firmware software application, a driver software application, a plug-in (e.g., add-in, add-on, and/or applet) software application, and/or any other suitable software applications.

In this disclosure, the term “memory 110” may be used to include one or more of the memory 110, ROM and RAM within the processor 140, or a memory card (e.g., a micro SD card, a memory stick) mounted on the electronic apparatus 100. In addition, various information within a range necessary to achieve the objectives of this disclosure may be stored in the memory 110, and the information stored in the memory 110 may be updated based on information received from an external device or input by a user.

The display 120 may output image data under the control of the processor 140. The display 120 may output images previously stored in the memory 110 under the control of the processor 140. Alternatively, the display 120 may display a screen corresponding to content information received from the hub device 200 under the control of the processor 140. The display 120 may be implemented as a liquid crystal display (LCD) panel, organic light emitting diodes (OLED), or the like. In addition, the display 120 may be implemented as a flexible display, a transparent display, or the like, depending on the circumstances. However, the display 120 according to the disclosure is not limited to a specific type. While FIG. 2 illustrates the electronic apparatus 100 as having the display 120 directly built therein, this may be interpreted as including not only cases in which the display 120 is mounted on the electronic apparatus 100 (e.g., a TV, a kiosk, a smartphone, a laptop PC, a tablet PC, etc.), but also cases in which the display 120 is connected to a separately provided display device (e.g., a monitor, TV, beam projector, electronic whiteboard, etc.) via various wired or wireless communication methods (e.g., a set-top box, a PC, a server, etc.).

The communication interface 130 is a component that communicates with various types of external devices using various communication methods. The communication interface 130 may include a wireless communication module or a wired communication module. Each communication module may be implemented in the form of at least one hardware chip.

The wireless communication module may be a module that communicates wirelessly with an external device. For example, the wireless communication module may include at least one of a Wi-Fi module, a Bluetooth module, an infrared communication module, or other communication modules.

The Wi-Fi module and the Bluetooth module may communicate via Wi-Fi or Bluetooth, respectively. In the case of using the Wi-Fi module or Bluetooth module, various connection information, such as a service set identifier (SSID), session key, etc. may be first transmitted and received to establish a communication connection, and thereafter, various information may be transmitted and received.

The infrared communication module performs communication according to infrared data association (IrDA) technology, which wirelessly transmit data over short distances using infrared rays present between visible light and millimeter waves.

In addition to the aforementioned communication methods, the other communication modules may include at least one communication chip that performs communication according to various wireless communication standards, such as Zigbee, 3G (3rd Generation), 3GPP (3rd Generation Partnership Project), LTE (Long Term Evolution), LTE-A (LTE Advanced), 4G (4th Generation), and 5G (5th Generation).

The wired communication module may be a module that communicates with an external device wiredly. For example, the wired communication module may include at least one of a local area network (LAN) module, an Ethernet module, a paired cable, a coaxial cable, a fiber optic cable, or an ultra wide-Band (UWB) module.

In particular, the communication interface 130 may communicate with the hub device 200. The communication interface 130 may receive status information on the hub device 200 and content information provided by an external device from the hub device 200 via a wireless or wired communication module.

The processor 140 may control the overall operations of the electronic apparatus 100. For example, the processor 140 may cause other components of the electronic apparatus 100 to perform various operations by executing instructions stored in the memory 110. For example, the processor 140 may be operatively connected to the memory 110 and control the operation of the electronic apparatus 100. In addition, the processor 140 may control the operation of the electronic apparatus 100 according to the disclosure by executing one or more instructions stored in the memory 110. The processor 140 may include one or more processors.

The processor 140 may be implemented as one or more integrated circuit (or circuitry) chips and may perform various data processing operations. The processor 140 may include at least one electrical circuit and may individually or collectively distribute and process instructions (or programs, data, etc.) stored in the memory 110. The processor 140 may include a processor assembly including one or more processing circuits. The processor 140 may include any processing circuit operative to control the performance and operations of one or more components (e.g., the memory 110) of the electronic apparatus 100. For example, the processor 140 (e.g., an application processor (AP)) may be implemented as a system on chip (SoC) (e.g., a single chip or chipset). For example, the processor 140 may be implemented as a plurality of cores (or at least one core circuit), a plurality of chips, or a plurality of chipsets. For example, the processor 140 may include one or more processing circuits. For example, the processor 140 may include one or more processing circuits configured to individually and/or collectively perform various functions of the disclosure.

The processor 140 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The processor 140 may control one or any combination of other components of the electronic apparatus 100 and perform operations related to communication or data processing. The processor 140 may execute one or more programs or instructions stored in the memory 110 of the electronic apparatus 100. For example, the processor 140 may perform a method according to an embodiment of the disclosure by executing one or more instructions stored in the memory 110.

In a case in which a method includes a plurality of operations according to an embodiment of the disclosure, a plurality of operations may be performed by one processor or by a plurality of processors. For example, in a case in which a first operation, a second operation, and a third operation are performed by a method according to an embodiment, the first operation, the second operation, and the third operation may all be performed by a first processor, or the first operation and the second operation may be performed by the first processor (e.g., a general-purpose processor) and the third operation may be performed by a second processor (e.g., an artificial intelligence-specific processor).

The processor 140 may be implemented as a single-core processor including one core or as one or more multi-core processors including a plurality of cores (e.g., homogeneous multi-cores or heterogeneous multi-cores). In a case in which the processor 140 is implemented as a multi-core processor, each of a plurality of cores included in the multi-core processor may include internal processor memory, such as cache memory or on-chip memory, and a common cache shared by a plurality of cores may be included in the multi-core processor. In addition, each of a plurality of cores (or some of a plurality of cores) included in the multi-core processor may independently read and execute program instructions for implementing the method according to an embodiment of the disclosure or all (or some) of a plurality of cores may be linked to read and execute program instructions for implementing the method according to an embodiment of the disclosure.

In a case in which the method according to an embodiment of the disclosure includes a plurality of operations, the plurality of operations may be performed by one of a plurality of cores included in the multi-core processor, or by a plurality of cores. For example, when a first operation, a second operation, and a third operation are performed by the method according to an embodiment, the first operation, the second operation, and the third operation may all be performed by a first core included in a multi-core processor, or the first and second operations may be performed by a first core included in the multi-core processor, and the third operation may be performed by a second core included in the multi-core processor.

In embodiments of the disclosure, a processor may refer to a system-on-chip (SoC) in which one or more processors and other electronic components are integrated, a single-core processor, a multi-core processor, or a core included in the single-core processor or the multi-core processor. A core may be implemented as a CPU, a GPU, an APU, a MIC, a DSP, an NPU, a hardware accelerator, or a machine learning accelerator, but embodiments of the disclosure are not limited thereto.

According to an embodiment, the processor 140 controls the display 120 to display a first screen, receives status information from the hub device 200 via the communication interface 130, identifies whether the hub device 200 is turned on based on the status information, and, based on the hub device 200 identified as being powered on, controls the display 120 to display a screen based on the presence of the external device 300 connected to the hub device 200.

According to an embodiment, based on the external device 300 being connected to the hub device, the processor 140 may receive content information provided by the connected external device 300 from the hub device via the communication interface 130.

According to an embodiment, the processor 140 may control the display 120 to display a second screen corresponding to the received content information.

According to an embodiment, based on no external device 300 being connected, the processor 140 may identify whether a new external device is connected to the hub device within a predetermined period of time.

According to an embodiment, based on no new external device being connected within the predetermined period of time, the processor 140 may control the display 120 to maintain the first screen.

According to an embodiment, based on a new external device being connected within the predetermined period of time, the processor 140 may receive content information provided by the new external device from the hub device via the communication interface 130.

According to an embodiment, the processor 140 may control the display 120 to display the second screen corresponding to the received content information.

According to an embodiment, based on a plurality of external devices being connected to the hub device, the processor 140 may receive content information provided by the plurality of external devices from the hub device via the communication interface 130.

In an embodiment, the processor 140 may control the display 120 to display a third screen including information on a plurality of external devices.

In an embodiment, based on an input for selecting one of the plurality of external devices being received, the processor 140 may control the display 120 to display the second screen corresponding to content information provided by a selected external device.

The input/output interface 150 is configured to input and output at least one of an audio signal or an image signal. The input/output interface 150 may receive at least one of an audio signal or an image signal from an external device and output a control command to the external device.

Depending on the implementation, the input/output interface 150 may be implemented as an interface that inputs and outputs only audio signals, an interface that inputs and outputs only image signals, or a single interface that inputs and outputs both audio and image signals.

In various embodiments of the disclosure, the input/output interface 150 may be implemented as at least one wired input/output interface among a high definition multimedia interface (HDMI), a mobile high-definition link (MHL), a universal serial bus (USB), a USB Type-C port, a display port (DP), a thunderbolt port, a video graphics array (VGA) port, an RGB port, a D-subminiature (D-SUB), and a digital visual interface (DVI). Depending on various embodiments, the wired input/output interface may be implemented as an interface that inputs/outputs only audio signals, an interface that inputs/outputs only image signals, or a single interface that inputs/outputs both audio and image signals.

Also, the electronic apparatus 100 may receive data through the wired input/output interface. However, this is merely an example of various embodiments, and the electronic apparatus 100 may receive power through the wired input/output interface. For example, the electronic apparatus 100 may receive power from an external battery via the USB Type-C port or from an outlet via a power adapter. As another example, the electronic apparatus 100 may receive power from an external device (e.g., a laptop or monitor) via a DP.

Audio signals may be input through a wired input/output interface, and image signals may be input through a wireless input/output interface (or communication interface). Alternatively, audio signals may be input through a wireless input/output interface (or communication interface), and image signals may be input through a wired input/output interface.

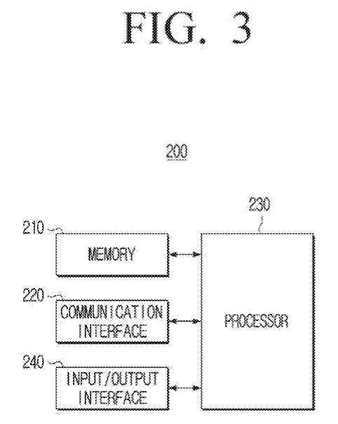

FIG. 3 is a block diagram illustrating a configuration of the hub device 200 according to at least one embodiment of the disclosure.

Referring to FIG. 3, the hub device 200 according to the disclosure may include memory 210, a communication interface 220, at least one processor 230 (hereafter “the processor 230”), and an input/output interface 240. However, this configuration is merely an example, and it is understood that new components may be added or some components may be omitted to implement the disclosure. Specific examples of the memory 210, communication interface 220, processor 230, and input/output interface 240 have been described above with reference to FIG. 2, and thus, a redundant description thereof will be omitted.

The communication interface 220 may include a wireless communication module or a wired communication module. Each communication module may be implemented in the form of at least one hardware chip. Specific examples of the wireless communication module and the wired communication module have been described above, and thus, a redundant description thereof will be omitted.

The communication interface 220 may receive content information regarding content provided by at least one external device. In an embodiment, the communication interface 220 may receive content information from the external device 300 via a wireless communication module. In another embodiment, the communication interface 220 may receive content information from the external device 300 via a wired communication module.

In addition, the communication interface 220 may transmit status information and content information of the hub device 200 to the electronic apparatus 100. In an embodiment, the communication interface 220 may transmit status information and content information to the electronic apparatus 100 via a wireless communication module. In another embodiment, the communication interface 220 may transmit status information and content information to the electronic apparatus 100 via a wired communication module. The input/output interface 240 may receive at least one of an audio signal or an image signal from an external device and output a control command to the external device.

In various embodiments of the disclosure, the input/output interface 150 may be implemented as at least one wired input/output interface among a high definition multimedia interface (HDMI), a mobile high-definition link (MHL), a universal serial bus (USB), a USB Type-C port, a display port (DP), a thunderbolt port, a video graphics array (VGA) port, an RGB port, a D-subminiature (D-SUB), and a digital visual interface (DVI). Depending on various embodiments, the wired input/output interface may be implemented as an interface that inputs/outputs only audio signals, an interface that inputs/outputs only image signals, or a single interface that inputs/outputs both audio and image signals.

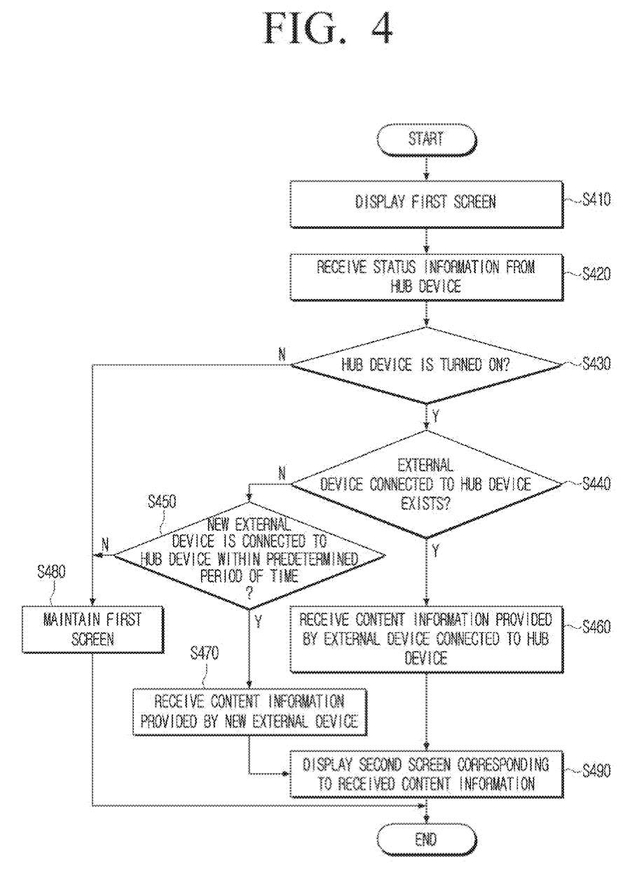

FIG. 4 is a flowchart illustrating a method for the electronic apparatus 100 to control a screen depending on a power status of a hub device 200 according to at least one embodiment of the disclosure.

The electronic apparatus 100 may display a first screen (S410).

Here, the first screen may refer to a screen displayed by the electronic apparatus 100 before switching to a screen displaying content from the hub device 200. In other words, the first screen may be a screen displayed by the electronic apparatus 100 before switching to an external input mode. For example, the first screen may be an application usage screen (or a built-in app screen) provided by the electronic apparatus 100, a screen displaying content stored in the electronic apparatus 100, or a home screen of the electronic apparatus 100. Alternatively, in a case in which the electronic apparatus 100 is displaying content received from a first external device and then switches the screen by receiving content from a second external device, the screen displaying the content received from the first external device may be the first screen. Alternatively, the first screen may refer to an existing screen, a previous screen, or a TV mode screen.

The electronic apparatus 100 may receive status information from the hub device 200 (S420). Here, the status information may refer to information regarding a status of the hub device 200. The status information may include at least one of identification information of the hub device 200, power information of the hub device 200, and connection information.

The electronic apparatus 100 may identify whether the hub device 200 is turned on (S430). The electronic apparatus 100 may identify whether the hub device 200 is turned on based on the received status information.

In an embodiment of the disclosure, the electronic apparatus 100 may identify whether the hub device 200 is turned on based on power information included in the received status information. For example, the hub device 200 may transmit status information including information regarding whether the hub device 200 is turned on or off to the electronic apparatus 100. The electronic apparatus 100 may identify that the hub device 200 is turned on based on the information regarding whether the hub device 200 is turned on.

In another embodiment of the disclosure, based on status information being received from the hub device 200, the electronic apparatus 100 may identify that the hub device 200 is turned on. While the hub device 200 cannot transmit status information to the electronic apparatus 100 when powered off, it may transmit status information to the electronic apparatus 100 when powered on. Therefore, the electronic apparatus 100 may identify the hub device 200 as being turned on based on status information beginning to be received from the hub device 200.

Specifically, the electronic apparatus 100 may periodically transmit a signal requesting status information to the hub device 200. Based on status information not being received from the hub device 200 in response to the transmitted signal, the electronic apparatus 100 may identify the hub device 200 as being turned off, and based on status information being received, the electronic apparatus 100 may identify the hub device 200 as being turned on, i.e., as being powered on.

However, this is merely an example, and the electronic apparatus 100 may identify that the hub device 200 is turned on based on a specific signal being received from the hub device 200, although the status information is not received. For example, the electronic apparatus 100 may identify that the hub device 200 is turned on based on receiving content information provided by an external device from the hub device 200.

Based on the hub device 200 being turned on, the electronic apparatus 100 may identify that the user intends to switch to external input through the hub device 200. Accordingly, the electronic apparatus 100 may control the displayed screen based thereon.

Based on identifying that the hub device 200 is turned on(S430-Y), the electronic apparatus 100 may control the displayed screen based on the presence or absence of the external device 300 connected to the hub device 200. In a case in which the hub device 200 is powered on, there may not be the external device 300 connected to the hub device 200 or at least one external device 300 may be connected. In this case, the electronic apparatus 100 may identify the user’s intention to switch to external input based on the external device 300 being connected to the hub device 200 or based on there is no external device 300 but a new external device being connected within a certain period of time. Accordingly, the electronic apparatus 100 may display a different screen based on the presence or absence of the external device 300 connected to the hub device 200.

Based on the presence of the external device 300 connected to the hub device 200 (S440-Y), the electronic apparatus 100 may receive content information provided by the external device 300 connected to the hub device 200 from the hub device 200 (S460).

At this time, the content information may refer to information on the content provided by the external device 300. Content information may include at least one of video or audio information included in the content provided by the external device 300 and metadata corresponding to the content. Video information may include information regarding video resolution, refresh rate, color format, color depth, HDR information, and dynamic metadata. Audio information may include information regarding audio format, sampling rate, and channel configuration. Metadata corresponding to the content is additional information for describing the content and may include the content’s title, description, category, etc.

FIG. 4 illustrates that the electronic apparatus 100 receives status information from the hub device 200 and identifies the hub device 200 as being powered on before receiving the content information. However, this is merely an example, and the electronic apparatus 100 may also receive both status information and content information from the hub device 200.

That is, in an embodiment, based on the external device 300 being connected to the hub device 200, the electronic apparatus 100 may receive status information from the hub device 200 and content information provided by the external device 300 together. At this time, based on identifying that the hub device 200 is turned on through the received status information, the electronic apparatus 100 may display a second screen corresponding to the received content information.

The electronic apparatus may display a second screen corresponding to the received content information (S490). Based on the received content information, the electronic apparatus 100 may display the second screen corresponding to the content information.

In this case, the second screen may refer to a screen displaying content provided by the external device 300. In other words, the second screen may be an external input screen. Alternatively, the second screen may refer to an external input mode screen or an input source screen.

In an embodiment of the disclosure, the second screen may include not only content provided by the external device 300 but also a notification UI indicating that the screen switches to the external input screen. The notification UI may include an icon along with a notification text.

For example, based on a tablet PC being connected to the hub device 200, the electronic apparatus 100 may receive content information provided by the tablet PC from the hub device 200 and display a screen corresponding to the content information (i.e., a screen for content provided by the tablet PC). At this time, the electronic apparatus 100 may also display a notification UI stating, “Switching to external input.”

Through this, the electronic apparatus 100 may identify the user’s intent and switch to the external input screen without any separate user action, thereby enhancing convenience. This is because, the presence of the external device 300 being connected to the hub device 200 may be considered that the user intends to switch to external input.

Based on the absence of the external device 300 connected to the hub device 200 (S440-N), the electronic apparatus 100 may identify whether a new external device is connected to the hub device 200 within a predetermined period of time (S450).

The electronic apparatus 100 may identify whether a new external device is connected to the hub device 200 based on information received from the hub device 200. Specifically, the electronic apparatus 100 may receive at least one of connection information or content information from the hub device 200 to identify whether a new external device is connected to the hub device 200.

In an embodiment of the disclosure, based on a new external device being connected to the hub device 200, the hub device 200 may transmit connection information indicating the connection of the new external device to the electronic apparatus 100. The electronic apparatus 100 may identify the connection of the new external device based on the received connection information.

In another embodiment of the disclosure, based on a new external device being connected to the hub device 200, the hub device 200 may transmit content information provided by the new external device to the electronic apparatus 100. Based on the received content information, the electronic apparatus 100 may identify the connection of the new external device.

The predetermined period of time may be a reference period of time for identifying the user’s intent based on the time taken until the external device 300 is connected after the hub device 200 was powered on. Even if no external device 300 is connected to the hub device 200, if the user connects the external device 300 to the hub device 200 within the predetermined period of time, the electronic apparatus 100 may identify that the user intends to switch to external input. The predetermined period of time may be set using various methods.

In an embodiment of the disclosure, the predetermined period of time may be a time stored in the electronic apparatus 100. For example, the electronic apparatus 100 may be configured to switch to the external input screen based on identifying that the hub device 200 is powered on and the external device 300 is connected to the hub device 200 within one minute.

In an embodiment of the disclosure, the predetermined period of time may be a time arbitrarily set by the user. For example, the user may configure the electronic apparatus 100 to switch to the external input screen if the hub device 200 is powered on and the external device 300 is connected within one minute.

In an embodiment of the disclosure, the predetermined period of time may be a time estimated by the electronic apparatus 100 based on the user’s usage information regarding the hub device 200. In this case, the usage information regarding the hub device 200 may include at least one of information regarding the user’s history of turning on the hub device 200, information regarding the user’s history of connecting the external device 300 to the hub device, or information regarding the user’s history of switching to the external input screen via the hub device 200. For example, the electronic apparatus 100 may store a record of the time elapsed until the external device 300 is connected after the user turned on the hub device 200 and estimate the predetermined period of time by averaging the stored time records. Alternatively, the usage information may refer to usage history information or history information.

The electronic apparatus 100 may identify whether the external device 300 is connected to the hub device 200 within the predetermined period of time based on the time at which the hub device 200 is identified as being powered on and the time at which information is received from the hub device 200. The electronic apparatus 100 may obtain the time elapsed until connection information (or content information) is received from the hub device 200 after the hub device 200 was identified as being powered on, and identify whether the elapsed time is within the predetermined period of time.

While the electronic apparatus 100 has been described above as identifying whether a new external device is connected to the hub device 200 within the predetermined period of time, this is merely an embodiment according to the disclosure. The hub device 200 may also identify whether a new external device is connected within the predetermined period of time after power is turned on and transmit a control signal corresponding to the identification result to the electronic apparatus 100. The electronic apparatus 100 may also display a screen based on the received control signal.

Based on a new external device being connected to the hub device 200 within the predetermined period of time (S450-Y), the electronic apparatus 100 may receive content information provided by the new external device from the hub device 200 (S470).

In an embodiment of the disclosure, after identifying that the new external device is connected to the hub device 200, the electronic apparatus 100 may receive content information provided by the new external device from the hub device 200.

The electronic apparatus 100 may also receive connection information and content information provided by the new external device from the hub device 200.

The electronic apparatus may display a second screen corresponding to the received content information (S490).

Through this, the electronic apparatus may identify the user’s intent to switch to external input and switch to the external input screen without any separate user action, thereby enhancing user convenience.

Based on no new external device being connected to the hub device 200 within the predetermined period of time (S450-N), the electronic apparatus 100 may maintain the first screen (S480).

Even if the hub device 200 is powered on, if there is no external device 300 connected to the hub device 200, the electronic apparatus 100 may maintain the first screen because the user is considered not to be intended to switch to external input.

In this case, even if the hub device 200 is powered on, the existing screen may be maintained so as not to disrupt the user’s experience.

In addition, if the hub device 200 is identified not to be powered on (S430-N), the electronic apparatus 100 may maintain the first screen (S480).

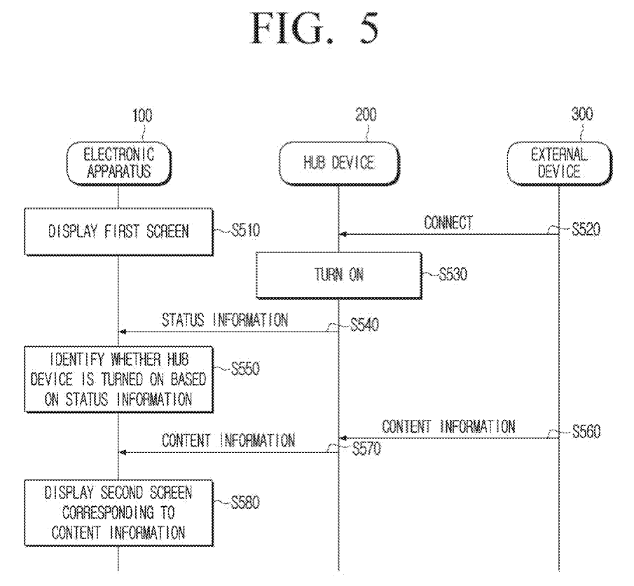

FIG. 5 is a diagram illustrating the operations of the electronic apparatus 100, the hub device, and the external device 300 based on the hub device 200 and the external device 300 being connected according to at least one embodiment of the disclosure.

FIG. 5 illustrates the operations among the electronic apparatus 100, the hub device 200, and the external device 300 based on the hub device 200 and the external device 300 being connected and the hub device 200 being powered on. The specific operations of the electronic apparatus 100 have been described above with reference to FIG. 4, so a detailed description will be omitted.

The electronic apparatus 100 may display a first screen (S510). The first screen may refer to a screen of the electronic apparatus 100 displayed before switching to a screen displaying content of the hub device 200.

The hub device 200 and the external device 300 may be connected before the hub device 200 is powered on (S520). The user may connect the external device 300 before powering on the hub device 200 to use external input or may use the external device 300 while the external device 300 is permanently connected to the hub device 200.

The hub device 200 may be turned on (S530).

The turned-on hub device 200 may transmit status information to the electronic apparatus 100 (S540). As described above, the status information may include at least one of identification information of the hub device 200, power information of the hub device 200, or connection information.

The electronic apparatus 100 may identify whether the hub device 200 is turned on based on the received status information (S550). In an embodiment, the electronic apparatus 100 may identify whether the hub device 200 is turned on based on the power information included in the status information. In another embodiment, based on the status information received from the hub device 200, the electronic apparatus 100 may identify that the hub device 200 is turned on.

Based on the electronic apparatus 100 identifying that the hub device 200 is turned on, the external device 300 may transmit content information to the hub device 200 (S560), and the hub device 200 may transmit the content information to the electronic apparatus 100 (S570).

As described above, the hub device 200 may transmit both status information of the hub device 200 and content information provided by the external device 300 to the electronic apparatus 100.

The electronic apparatus 100 may display a second screen corresponding to the received content information (S580). Through this, the electronic apparatus 100 may switch to the external input screen based on the hub device 200 connected to the external device 300 being turned on, without any separate user action.

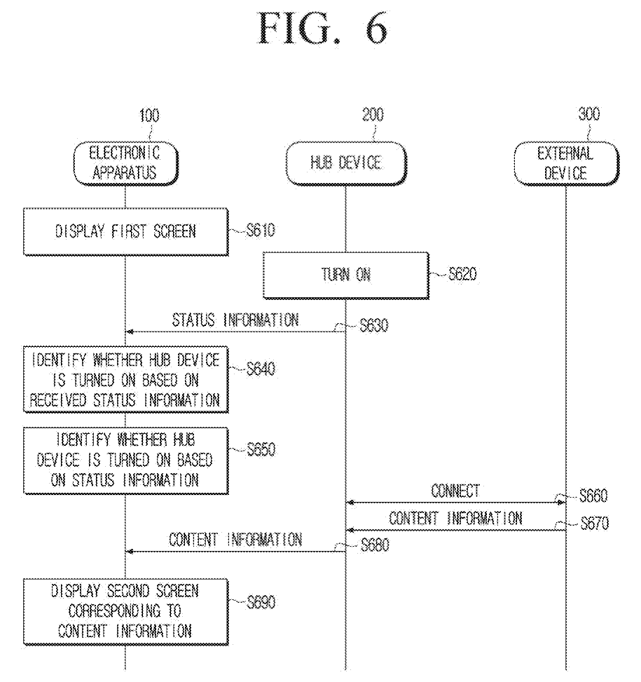

FIG. 6 is a diagram illustrating the operations of the electronic apparatus 100, a hub device 200, and the external device 300 based on the hub device 200 not being connected to an external device, according to at least one embodiment of the disclosure.

FIG. 6 illustrates the operations among the electronic apparatus 100, the hub device 200, and the external device 300 based on the hub device 200 being powered on and then the external device 300 being connected to the hub device 200. The specific operations of the electronic apparatus 100 have been described above with reference to FIG. 4, so a detailed description will be omitted.

The electronic apparatus 100 may display a first screen (S610). The first screen may refer to the screen displayed by the electronic apparatus 100 before switching to a screen displaying content from the hub device 200.

The hub device 200 may be turned on (S620).

The turned-on hub device 200 may transmit status information to the electronic apparatus 100 (S630). As described above, the status information may include at least one of identification information of the hub device 200, power information of the hub device 200, or connection information.

The electronic apparatus 100 may identify whether the hub device 200 is turned on based on the received status information (S640). In an embodiment, the electronic apparatus 100 may identify whether the hub device 200 is turned on based on power information included in the status information. In another embodiment, the electronic apparatus 100 may identify that the hub device 200 is turned on based on the status information received from the hub device 200.

After the electronic apparatus 100 identifies that the hub device 200 is turned on, if there is no external device 300 connected to the hub device 200, the electronic apparatus 100 may maintain the first screen (S650). Even if the hub device 200 is turned on, since there is no connected external device 300, it cannot be identified that the user intends to switch to the external input screen. Therefore, the electronic apparatus 100 may maintain the first screen.

After the hub device 200 is turned on, the external device 300 may be connected to the hub device 200 within a predetermined period of time (S660). The predetermined period of time may be a time stored in the electronic apparatus 100 or a time set by the user. Alternatively, the predetermined period of time may be an estimated time based on the user’s usage information.

When the external device 300 and the hub device 200 are connected, the external device 300 may transmit content information to the hub device 200 (S670). In addition, the hub device 200 may transmit the content information to the electronic apparatus 100 (S680).

The electronic apparatus may display a second screen corresponding to the received content information based on the content information (S690). Through this, based on the hub device 200 being powered on and the external device 300 being connected, the electronic apparatus 100 may switch to the external input screen even without any additional user action.

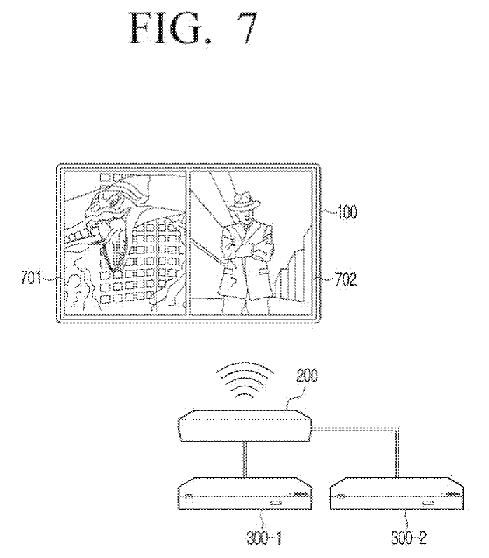

In the above, it is assumed that a single external device 300 is connected to the hub device 200, but, without being limited thereto, a plurality of external devices may also be connected to the hub device 200. Hereinafter, a case in which a plurality of external devices are connected to the hub device 200 will be described with reference to FIG. 7.

FIG. 7 is a diagram illustrating the operation of the electronic apparatus 100 when the hub device 200 connected to a plurality of external devices is turned on, according to an embodiment of the disclosure.

Referring to FIG. 7, a first external device 300-1 and a second external device 300-2 connected to the hub device 200 are illustrated. However, this is merely an example, and two or more external devices may be connected to the hub device 200. In addition, while FIG. 7 illustrates the hub device 200 and the external devices as being connected wiredly, this is only an example. Some of the plurality of external devices may be connected to the hub device 200 wiredly, while others may be connected wirelessly to the hub device 200. In addition, it should be understood that all of the plurality of external devices may be connected wirelessly to the hub device 200.

If the hub device 200 is identified as being powered on and there are a plurality of external devices connected to the hub device 200, the electronic apparatus 100 may receive content information provided by the plurality of external devices from the hub device 200.

In an embodiment of the disclosure, the electronic apparatus 100 may receive status information from the hub device 200, identify whether the hub device 200 is powered on, and then receive content information provided by a plurality of external devices from the hub device 200.

In another embodiment of the disclosure, the electronic apparatus 100 may receive both status information and content information provided by a plurality of external devices from the hub device 200. In this case, based on identifying that the hub device 200 is powered on based on the status information, the electronic apparatus 100 may display a screen based on the received content information.

The electronic apparatus 100 may receive content information provided by at least one of a plurality of external devices connected to the hub device 200. In an embodiment, the electronic apparatus 100 may receive content information provided by an external device that is powered on among a plurality of external devices connected to the hub device 200. In another embodiment, the electronic apparatus 100 may receive content information provided by two or more external devices identified based on a predetermined priority among a plurality of external devices.

The electronic apparatus 100 may display a third screen including information on a plurality of external devices. Based on the received content information, the electronic apparatus 100 may display the third screen including information on a plurality of external devices.

In this case, the third screen may refer to a screen that displays a plurality of external devices connected to the hub device 200 and allows the user to select one external device. The third screen may include information on a plurality of external devices and allows the user to select one external device. Alternatively, the third screen may refer to an external input selection screen or a multi-view screen.

The third screen may include at least one of the names or user-defined names of each of a plurality of external devices connected to the hub device 200, icons or images corresponding to each external device, or content screens provided by each external device.

Referring to FIG. 7, the electronic apparatus 100 may divide the screen and display content screens provided by a plurality of external devices on each divided screen. Specifically, the third screen may include a first divided screen 701 and a second divided screen 702. The first divided screen 701 may display the content screen provided by a first external device 300-1, and the second divided screen 702 may display the content screen provided by a second external device 300-2.

For example, based on a game console and a tablet PC being connected to the hub device 200, the electronic apparatus 100 may divide the screen into two screens and display a game screen provided by the game console and a screen provided by the tablet PC on each screen. However, this is only an embodiment, and the form of the third screen is not limited to this and may include two or more divided screens.

However, the third screen illustrated in FIG. 7 is only an embodiment. In another embodiment of the disclosure, the electronic apparatus 100 may display a third screen that includes names, icons, images, or information corresponding to each of a plurality of external devices. For example, the electronic apparatus 100 may display names, icons, images, or other information corresponding to each of the plurality of external devices in a list or grid format. For example, based on the game console and the tablet PC being connected to the hub device 200, the electronic apparatus 100 may display the names and icons of the game console and the tablet PC in a list or grid format.

The user may select one external device to be displayed through the electronic apparatus 100 among a plurality of external devices. The electronic apparatus 100 may receive an input to select one of the plurality of external devices. In an embodiment of the disclosure, the electronic apparatus 100 may receive an input to select one external device through a remote controller, a touchpad, an AI speaker, or the like. In another embodiment, based on the user selecting an external device on a terminal device, the electronic apparatus 100 may receive a control signal corresponding to the input for selecting the external device from the terminal device.

Based on the input for selecting one of a plurality of external devices being received, the electronic apparatus 100 may display a second screen corresponding to content information provided by the selected external device. Based on the user selecting one of the plurality of external devices displayed on the third screen, the electronic apparatus 100 may display a screen of the external device selected by the user.

While it has been described with reference to FIGS. 4 through 7 based on the assumption that the hub device 200 is powered on, the disclosure is not necessarily limited thereto. Even if the hub device 200 switches from a standby mode to an active mode or even if the connection of the hub device 200 and the electronic apparatus 100 are connected from a disconnected state, the user is considered to intend to switch to an external input, and thus the electronic apparatus 100 may control the screen in the same manner.

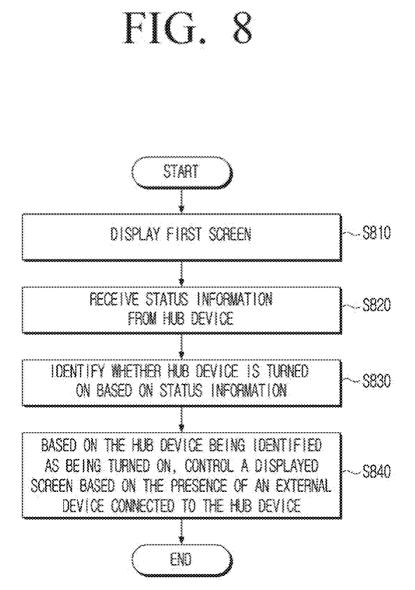

FIG. 8 is a flowchart illustrating a method of controlling the electronic apparatus 100 according to an embodiment of the disclosure.

The electronic apparatus 100 may display a first screen (S810). The first screen may refer to a screen displayed before the electronic apparatus 100 switches to a screen displaying content from the hub device 200.

The electronic apparatus 100 may receive status information from the hub device 200 (S820). The status information may refer to information regarding the status of the hub device 200. The status information may include at least one of identification information of the hub device 200, power information of the hub device 200, or connection information.

The electronic apparatus 100 may identify whether the hub device is turned on based on the status information (S830).

Based on the hub device 200 being identified as being turned on, the electronic apparatus 100 may control the displayed screen based on the presence of an external device connected to the hub device 200 (S840). Based on the presence of the external device 300 connected to the hub device 200, the electronic apparatus 100 may display a second screen corresponding to content information provided by the external device 300. In the case of the absence of the external device 300 connected to the hub device 200, based on the hub device 200 being powered on and a new external device being connected within a predetermined period of time, the electronic apparatus 100 may display the second screen corresponding to content information provided by the new external device. Based on no new external device being connected within the predetermined period of time, the electronic apparatus 100 may maintain the first screen.

The various embodiments described above may be implemented independently for each embodiment, but are not necessarily limited thereto, and may be implemented in part or in whole in combination with at least one other embodiment.

In addition, the methods according to the various embodiments of the disclosure described above may be implemented only by software upgrade or hardware upgrade of the existing electronic apparatus.

According to an embodiment of the disclosure, the control method according to the various embodiments described above may be implemented as software including commands stored in a non-transitory machine-readable storage medium that may be read by various devices (machines) (e.g., computers), such as the electronic apparatus 100.

Based on the instruction being executed by the processor 140, the processor may directly perform a function corresponding to the instruction, or other components may perform the function corresponding to the instruction under a control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

In addition, according to one or more embodiments of the disclosure, the methods according to the various embodiments described above may be included and provided in a computer program product. The computer program product may be traded as a product between a seller and a purchaser. The computer program product may be distributed in a form of the machine-readable storage medium (for example, a compact disc read only memory (CD-ROM)), or may be distributed online through an application store (for example, PlayStore^{TM}). Based on the online distribution, at least a part of the computer program product may be at least temporarily stored or temporarily provided in a storage medium, such as a memory of a server of a manufacturer, a server of an application store or a relay server.

In addition, each component (e.g., module or program) in the various embodiments described above may include a single entity or a plurality of entities, and some of the corresponding sub-components described above may be omitted or other sub-components may be further included in the various embodiments. Alternatively or in addition, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner, or a heuristic manner, at least some of the operations may be performed in a different order or be omitted, or other operations may be added.

Although specific embodiments of the disclosure are shown and described hereinabove, the disclosure is not limited to the above-mentioned specific embodiments, and may be variously modified by those skilled in the art to which the disclosure pertains without departing from the scope and spirit of the disclosure as disclosed in the accompanying claims. These modifications should also be understood to fall within the scope and spirit of the disclosure.

What is claimed is:

1. An electronic apparatus comprising:
a communication interface;
a display;
memory configured to store at least one instruction; and
at least one processor,
wherein the at least one instruction, when executed by the at least one processor individually or collectively, causes the electronic apparatus to:
display a first screen on the display;
obtain status information from a hub device through the communication interface;
identify whether the hub device is turned on based on the status information; and
based on identifying that the hub device is turned on, control a screen displayed on the display based on whether an external device is connected to the hub device.

2. The electronic apparatus of claim 1, wherein the at least one instruction, when executed by the at least one processor individually or collectively, causes the electronic apparatus to:
based on the external device being connected to the hub device, obtain content information provided by the external device from the hub device through the communication interface and
display, on the display, a second screen corresponding to the content information .

3. The electronic apparatus of claim 1, wherein the at least one instruction, when executed by the at least one processor individually or collectively, causes the electronic apparatus to:
based on the external device not being connected to the hub device, identify whether a new external device is connected to the hub device within a predetermined period of time; and
based on identifying that the new external device is not connected to the hub device within the predetermined period of time, maintain the display of the first screen on the display.

4. The electronic apparatus of claim 3, wherein the at least one instruction, when executed by the at least one processor individually or collectively, causes the electronic apparatus to:
based on identifying that the new external device is connected to the hub device within the predetermined period of time, obtain content information provided by the new external device from the hub device through the communication interface; and
display, on the display, a second screen corresponding to the content information.

5. The electronic apparatus of claim 1, wherein the at least one instruction, when executed by the at least one processor individually or collectively, causes the electronic apparatus to:
based on a plurality of external devices being connected to the hub device, obtain content information provided by the plurality of external devices from the hub device through the communication interface; and
display, on the display, a third screen including information on the plurality of external devices.

6. The electronic apparatus of claim 5, wherein the at least one instruction, when executed by the at least one processor individually or collectively, causes the electronic apparatus to:
based on an input for selecting one of the plurality of external devices being received, display, on the display, a second screen corresponding to content information provided by the selected external device.

7. The electronic apparatus of claim 1, wherein the status information comprises at least one of identification information of the hub device, power information of the hub device, or connection information.

8. A method of controlling an electronic apparatus, the method comprising:
displaying a first screen on a display of the electronic apparatus;
obtaining status information from a hub device;
identifying whether the hub device is turned on based on the status information; and
based on identifying that the hub device is turned on, controlling a screen displayed on the display based on whether an external device is connected to the hub device.

9. The method of claim 8, wherein the controlling of the screen displayed on the display comprises:
based on the external device being connected to the hub device, obtaining content information provided by the external device from the hub device; and
displaying, on the display, a second screen corresponding to the content information.

10. The method of claim 8, wherein the controlling of the screen displayed on the display further comprises:
based on the external device not being connected to the hub device, identifying whether a new external device is connected to the hub device within a predetermined period of time; and
based on identifying that the new external device is not connected to the hub device within the predetermined period of time, maintaining the displaying of the first screen.

11. The method of claim 10, wherein the controlling of the screen displayed on the display further comprises:
based on identifying that the new external device is connected to the hub device within the predetermined period of time, obtaining content information provided by the new external device from the hub device; and
displaying, on the display, a second screen corresponding to the content information.

12. The method of claim 8, wherein the controlling of the screen displayed on the display further comprises:
based on a plurality of external devices being connected to the hub device, obtaining content information provided by the plurality of external devices from the hub device; and
displaying, on the display, a third screen including information on the plurality of external devices.

13. The method of claim 12, wherein the controlling of the screen displayed on the display further comprises:
based on an input for selecting one of the plurality of external devices being received, displaying, on the display, a second screen corresponding to content information provided by the selected external device.

14. The method of claim 8, wherein the status information comprises at least one of identification information of the hub device, power information of the hub device, or connection information.

15. A non-transitory computer-readable recording medium storing a program that is executed by at least one processor of an electronic apparatus to perform a method comprising:
displaying a first screen on a display of the electronic apparatus;
obtaining status information from a hub device;
identifying whether the hub device is turned on based on the status information; and
based on identifying that the hub device is turned on, controlling a screen displayed on the display based on whether an external device is connected to the hub device.

16. The non-transitory computer-readable recording medium of claim 15, wherein the controlling of the screen displayed on the display comprises:
based on the external device being connected to the hub device, obtaining content information provided by the external device from the hub device; and
displaying, on the display, a second screen corresponding to the content information.

17. The non-transitory computer-readable recording medium of claim 15, wherein the controlling of the screen displayed on the display further comprises:
based on the external device not being connected to the hub device, identifying whether a new external device is connected to the hub device within a predetermined period of time; and
based on identifying that the new external device is not connected to the hub device within the predetermined period of time, maintaining the displaying of the first screen.

18. The non-transitory computer-readable recording medium of claim 17, wherein the controlling of the screen displayed on the display further comprises:
based on identifying that the new external device is connected to the hub device within the predetermined period of time, obtaining content information provided by the new external device from the hub device; and
displaying, on the display, a second screen corresponding to the content information.

19. The non-transitory computer-readable recording medium of claim 15, wherein the controlling of the screen displayed on the display further comprises:
based on a plurality of external devices being connected to the hub device, obtaining content information provided by the plurality of external devices from the hub device; and
displaying, on the display, a third screen including information on the plurality of external devices.

20. The non-transitory computer-readable recording medium of claim 19, wherein the controlling of the screen displayed on the display further comprises:
based on an input for selecting one of the plurality of external devices being received, displaying, on the display, a second screen corresponding to content information provided by the selected external device.
